(19) United States
(12) Patent Application Publication
(10) Pub. No.: US 2026/0364750 A1
(43) Pub. Date: Nov. 19, 2026

(54) HAND HELD CLAMPING DEVICE WITH MOTORIZED CLAMPING

(71) Applicant: Tory Weber, Calgary (CA)

(72) Inventor: Tory Weber, Calgary (CA)

(21) Appl. No.: 19/153,795

(22) PCT Filed: Feb. 1, 2024
(86) PCT No.: PCT/CA2024/050125

§ 371 Date: Aug. 5, 2025

Related U.S. Application Data
(60) Provisional application No. 63/483,379, filed on Feb. 6, 2023.

(51) Int. Cl. B25B 5/06

(52) U.S. Cl. CPC B25B 5/068

(57) ABSTRACT

A clamping device has a first jaw fixedly supported on a clamping frame and a second jaw supported on the clamping frame by a motorized driving assembly so as to be movable towards and away from the first jaw on the clamping frame along a longitudinal clamping axis. The driving assembly includes a pivotal actuator handle such that a drive motor drives the second jaw towards or away from the first jaw in response to displacement of the actuator handle in a first direction or second direction of rotation respectively. The actuator handle thus allows an operator to fully control the positioning of the clamping jaws in a single-handed operation so that the other hand can be used for holding the object to be clamped.

### FIELD OF THE INVENTION

The present invention relates to a clamping device comprising first and second jaws which are movable relative to one another for clamping an object therebetween or for applying a spreading tension to the object, and more particularly the present invention relates to a clamping device which sized to be held in the hands of a user while having motorized control of the clamping or spreading force applied to the object.

### BACKGROUND

International Patent Application no. WO2020/056490 by Weber describes various clamping devices having a motorized driving assembly for driving one clamping jaw relative to another clamping jaw for ease of operation. A single trigger is used to actuate clamping the jaws towards one another or actuate spreading of the jaws using a second actuator button to change the actuating direction of the single trigger. Some examples of the clamping devices disclosed are limited in their overall clamping range and are thus unable to accommodate clamping larger objects.

### SUMMARY OF THE INVENTION

According to one aspect of the invention there is provided a clamping device for clamping an object, the device comprising:
a clamping frame;
a first jaw supported on the clamping frame in fixed relation to the clamping frame;
a motorized driving assembly supported on the clamping frame; and
a second jaw supported on the clamping frame by the motorized driving assembly so as to be movable towards and away from the first jaw on the clamping frame along a longitudinal clamping axis;
wherein the motorized driving assembly comprises:
   a drive motor operatively connected between the second jaw and the clamping frame so as to drive displacement of the second jaw relative to the first jaw; and
   an actuator handle supported for pivotal movement relative to the clamping frame about a rotary axis of the actuator handle;
wherein the drive motor drives the second jaw towards the first jaw in response to displacement of the actuator handle in a first direction of rotation about the rotary axis; and
wherein the drive motor drives the second jaw away from the first jaw in response to displacement of the actuator handle in a second direction of rotation about the rotary axis.

Use of a single actuator handle that can drive the clamping jaws in two directions based on the direction of rotation of the actuator handle allows an operator to fully control the positioning of the clamping jaws in a single-handed operation so that the other hand can be used for holding the object to be clamped for example. The rotary actuator handle also provides a high degree of control over the position of the jaws and the clamping pressure applied by the jaws in a manner unseen in the prior art.

The rotary axis preferably lies parallel to the longitudinal clamping axis.

Preferably the actuator handle is elongated along the rotary axis of the actuator handle and shaped to be received within a gripped fist of a user.

The device may be further arranged such that (i) the drive motor drives the second jaw towards the first jaw in response to displacement of the actuator handle in the first direction of rotation about the rotary axis from a neutral position towards a first deflected position, (ii) the drive motor drives the second jaw away from the first jaw in response to displacement of the actuator handle in the second direction of rotation about the rotary axis from the neutral position towards a second deflected position, and (iii) the actuator handle is biased from each of the first deflected position and the second deflected position towards the neutral position. The drive motor preferably displaces the second jaw relative to the first jaw at a speed which is proportional to an amount of deflection of the actuator handle from the neutral position towards either of the first deflected position or the second deflected position.

The motorized drive assembly may include a screw member having a screw axis lying parallel to the longitudinal clamping axis and a collar member supported about the screw member in which the collar member is internally threaded and forms a threaded connection with the screw member. In this instance, a first member among the screw member and the collar member is preferably fixed relative to the second jaw and a second member among the screw member and the collar member is preferably driven to rotate by the drive motor whereby the second jaw is displaced along the longitudinal clamping axis. In the illustrated embodiment, the second member is directly coupled in fixed relation to a rotary output of the drive motor, the first member is the screw member, and the second member is collar member.

The actuator handle may comprise a sleeve receiving the drive motor within a hollow interior of the sleeve.

The clamping frame may include (i) an elongated rail extending parallel to the longitudinal clamping axis and supporting the first jaw fixedly thereon, (ii) a housing operatively connected to the elongated rail such that the rail is slidable longitudinally in a direction of the longitudinal clamping axis relative to the housing, and (iii) a latch arranged to selectively lock a position of the elongated rail relative to the housing. In this instance, the motorized driving assembly supports the second jaw on the housing of the clamping frame such that the second jaw is movable in the direction of the longitudinal sliding axis relative to the housing, whereby the second jaw is movable relative to the first jaw either by displacing the first jaw and the elongated rail relative to the housing or by displacing the second jaw relative to the housing using the drive motor. Preferably an overall range of movement of the first jaw and the elongated rail relative to the housing in the direction of the longitudinal sliding axis is greater than an overall range of movement of the second jaw relative to the housing in the direction of the longitudinal sliding axis. The clamping device may further include an auxiliary rail having a length which is different than a length of the elongated rail in which the auxiliary rail and the elongated rail are interchangeable with one another.

When the latch is pivotally supported on the housing, the latch is preferably biased towards an engaged position locking the elongated rail in position relative to the housing. In this instance, the latch may include a lever arranged to be engaged by a user to release the elongate rail from the latch. When the actuator handle is shaped to be received within a gripped fist of the user, preferably the lever is positioned adjacent the actuator handle so as to actuatable by an index finger of said gripped fist of the user when gripping the actuator handle.

The latch may comprise a spur gear rotatably supported on the housing in meshing engagement with a row of gear teeth extending along the elongated rail and a latch body arranged to selectively engage the spur gear and thereby lock the elongated rail relative to the housing by preventing rotation of the spur gear.

When the first jaw is offset radially from the elongated rail in a first direction, the housing may extend from the elongated rail in said first direction towards the drive assembly and the second jaw such that the drive assembly is also offset radially from the elongated rail in said first direction.

The clamping device may further include a base member having (i) a bottom side arranged to be supported on a horizontal supporting surface and (ii) a socket formed therein having an open top arranged to receive a bottom end of the housing inserted downward therein such that the elongated rail extends parallel to the horizontal supporting surface and the elongated rail is longitudinally adjustable relative to the housing and the base member, in which the first jaw, the second jaw, and the motorized drive assembly are supported above the elongated rail in a mounted position of the housing within the base member.

The elongated rail may comprise (i) an extruded main body spanning a length of the elongate rail and being formed of a first metal and (ii) a latching strip extending along a length of the extruded main body and being formed of a second metal, in which the latching strip is operatively connected to the latch to selectively lock the elongated rail relative to the housing, and in which the second metal is harder and denser than the first metal.

The motorized driving assembly may further comprise a transceiver arranged for wireless communication with an auxiliary input device such that the drive motor is operative to drive movement of the second jaw relative to the first jaw responsive to a wireless input signal from the auxiliary input device.

According to a second aspect of the present invention there is provided a clamping device for clamping an object, the device comprising:
an elongated rail having a longitudinal axis;
a first jaw supported in fixed relation on the elongated rail;
a housing operatively connected to the elongated rail such that the elongated rail and the first jaw supported thereon are longitudinally slidable relative to the housing in a direction of said longitudinal axis;
a latch arranged to selectively lock a position of the elongated rail relative to the housing;
a motorized driving assembly supported on the housing;
a second jaw supported on the housing by the motorized driving assembly such that the second jaw is movable relative to the housing towards and away from the first jaw on the elongated rail along a longitudinal clamping axis lying parallel to the longitudinal axis of the elongated rail;
the motorized driving assembly including (i) a drive motor operatively connected between the second jaw and the housing so as to drive displacement of the second jaw relative to the first jaw and (ii) an actuator operatively connected to the drive motor such that the drive motor drives displacement of the second jaw responsive to actuation by the actuator;
whereby the second jaw is movable relative to the first jaw either by displacing the first jaw and the elongated rail relative to the housing or by displacing the second jaw relative to the housing using the drive motor.

The use of a first adjustment of the jaws relative to one another by adjusting the first jaw on the rail relative to the housing together with a second adjustment of the jaws relative to one another by adjusting the second jaw relative to the housing under control of the motorized driving assembly allows for quick macro adjustments of the jaws and precise micro adjustments of the jaws within a single clamping device in a manner unseen in the prior art.

### BRIEF DESCRIPTION OF THE DRAWINGS

One embodiment of the invention will now be described in conjunction with the accompanying drawings in which:

FIG. 1 is a perspective view of the clamping device according to the present invention shown supported on the base member for mounting on a horizontal supporting surface;

FIG. 2 is a perspective view of a portion of the clamping device of FIG. 1 showing an opposing side relative to FIG. 1 and with the auxiliary jaws mounted in place of the first and second jaws of FIG. 1;

FIG. 3 is a perspective view of the clamping device similar to FIG. 2 but with a portion of the housing shown removed for illustrative purposes;

FIG. 4 is a sectional view of the clamping device along a vertical plane occupied by the longitudinal clamping axis of the jaws and the longitudinal axis of the rail;

FIG. 5 is a sectional view of the clamping device along a plane lying perpendicular to the longitudinal clamping axis of the jaws; and

FIG. 6 is a perspective view of the base member according to FIG. 1 shown separated from a remainder of the clamping device.

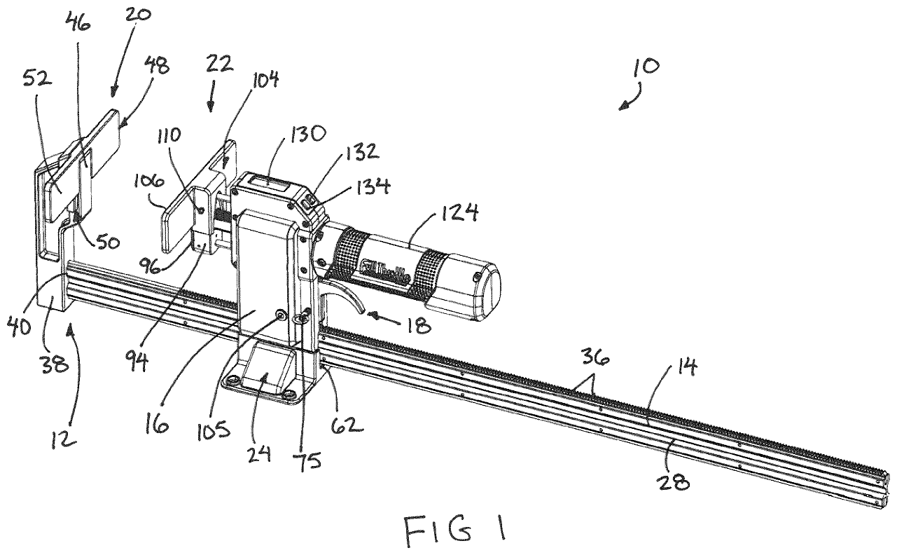

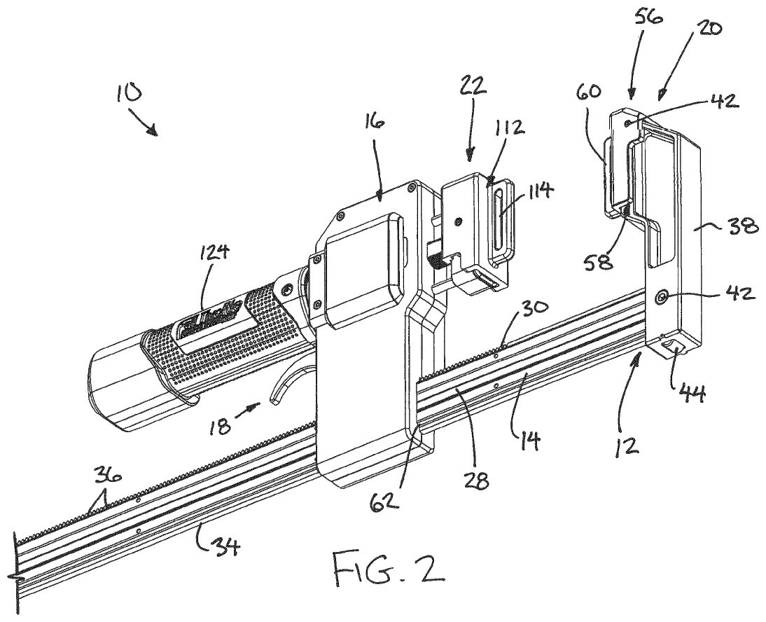

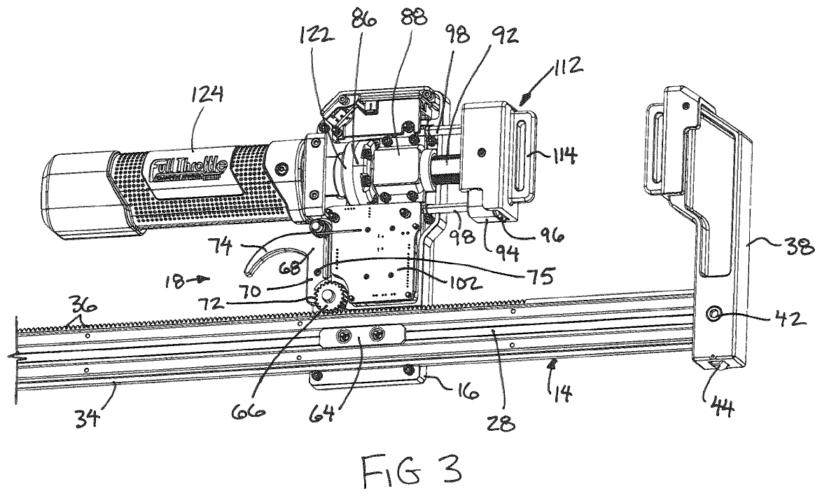

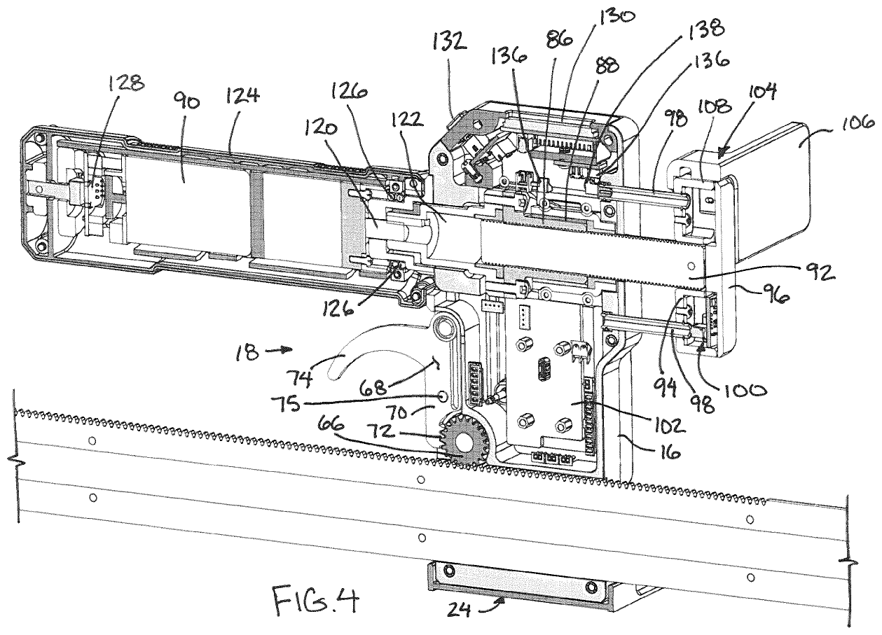

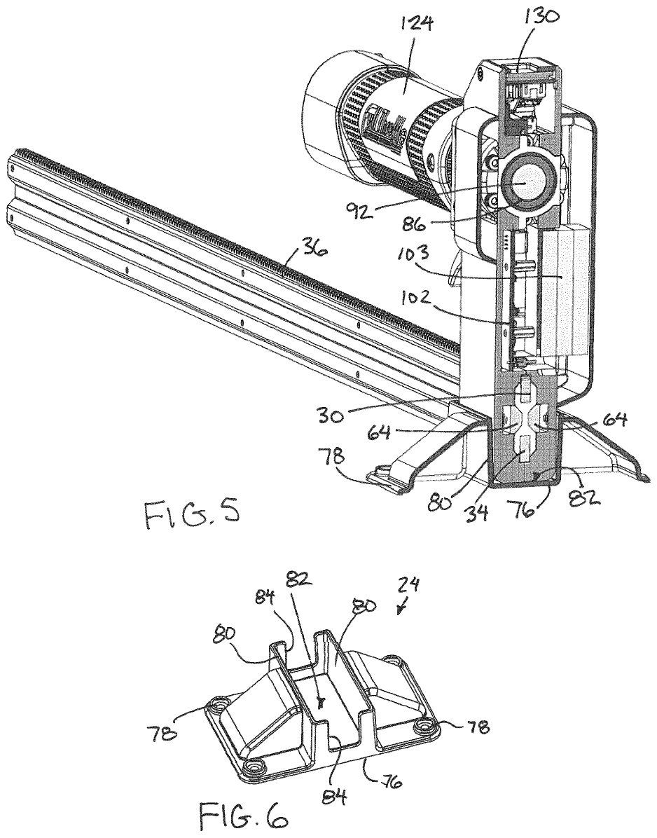

In the drawings like characters of reference indicate corresponding parts in the different figures.

### DETAILED DESCRIPTION

Referring to the accompanying figures there is illustrated a clamping device generally indicated by reference numeral 10. The clamping device 10 is particularly suited for clamping an object therein to apply a consistent and precisely controlled clamping pressure to the object for a large range of differently sized objects.

The clamping device 10 includes an adjustable clamping frame 12 in which the clamping frame 12 further includes an elongated rail 14, a housing 16 movable along the rail 14, and a latch 18 for selectively locking the housing relative to the rail 14. The clamping device 10 further includes (i) a first clamping jaw 20 arranged to be fixedly mounted onto one end of the rail 14 so as to be longitudinally adjustable with the rail relative to the housing 16, and a second clamping jaw 22 supported by a motorized drive assembly (described further below) so as to be adjustable relative to the housing 16 such that the second jaw is movable towards and away from the first jaw 20 along a longitudinal clamping axis of the clamping device. The longitudinal clamping axis lies parallel to the longitudinal axis of the rail 14 with the rail being similarly supported for longitudinal sliding movement in a direction of the longitudinal clamping axis.

The clamping device 10 cooperates with a base member 24 which defines an optional docking station for docking the clamping device 10 relative to a horizontal supporting surface such as a countertop for example. The base member 24 primarily supports the housing 16 therein such that the first jaw 20 on the rail 14 and the second jaw supported by the motorized driving assembly are each movable relative to the base member 24 supporting the housing thereon in a direction that is parallel to the supporting surface.

This arrangement provides a two-stage adjustment of the movement of the second clamping jaw 22 relative to the first clamping jaw 20 in the clamping direction of the longitudinal clamping axis as the jaws are moved towards and away from one another for clamping an object therebetween. More particularly, the two-stage adjustment includes a first macro adjustment enabling a larger range of movement of the second jaw relative to the first jaw by sliding the rail 14 relative to the housing 16 when the latch 18 is released, followed by a second micro adjustment limited to a smaller yet motorized range of movement of the second jaw relative to the first jaw by sliding the second jaw relative to the housing while the rail 14 remains locked by the latch 18 relative to the housing 16.

The rail 14 is elongated along the longitudinal axis of the rail between opposing first and second ends of the rail. The rail includes an extruded main body 26 occupying a majority of the cross-sectional area of the rail and spanning the full-length of the rail between opposing ends thereof. The main body is formed of a first extrudable metal, for example aluminum. The profile of the extruded main body is elongated in height relative to the width thereof so as to be taller between opposing top and bottom ends of the cross section of the rail. Opposing upright side surfaces of the rail each include a recess 28 formed in the side thereof such that the cross-sectional shape of the main body 28 resembles an hourglass shape.

The rail 14 further includes a latching strip 30 forming the top surface of the rail 14 by receiving the latching strip 30 partly recessed into a top channel 32 formed at the top end of the main body 26 such that the latching strip protrudes partially from the top end of the main body 26. Likewise, an opposing bottom strip 34 is received within a corresponding channel 36 formed in the bottom of the main body 26 of the rail such that the bottom strip similarly protrudes outward beyond the bottom end of the main body. Both the latching strip 30 and the bottom strip 34 are formed of a second metal which is harder and denser than the first metal of the main body, for example by being formed of a hardened steel. The latching strip 30 is machined to include a row of gear teeth formed along the top side thereof for cooperation with the latch 18 as described in further detail below. Each of the latching strip 30 and the bottom strip 34 span the full length of the main body in the longitudinal direction of the rail. The combination of the main body 26 with the latching strip 30 and the bottom strip 34 combine the advantages of minimizing the overall weight of the rail while increasing the durability of the top and bottom edges of the rail.

The first clamping jaw 20 is mounted on one end of the rail 14 by a first upright frame member 38. The first upright frame member 38 includes a rail socket 40 formed on the inner side of the upright frame member facing towards the housing, adjacent a bottom end of the upright frame member, so as to be arranged to receive the end of the rail slidably inserted therein. A set screw 42 is penetrated through a side wall of the socket 40 from the exterior of the upright frame member 38 for cooperation with the end of the rail received within the socket. Tightening the screw 42 about an axis of the screw lying perpendicularly to the rail serves to selectively lock the first upright frame member to the end of the rail in fixed relation thereto. The remainder of the rail 14 has a continuous cross-section along the full-length thereof from the first upright frame member 38 to the opposing second end of the rail. In this manner, the rail is slidably removable from the housing simply by sliding the rail longitudinally out of the housing as the first upright frame member 38 is displaced away from the housing.

A plurality of auxiliary rails (not shown) can be included with the clamping device in which each of the rails is different in length from the other rails. The rails are configured identically to one another, other than the length thereof, so as to be interchangeable with one another. Selecting a different size rail will allow the overall clamping range of the clamping device to be changed. To interchange the rails, the set screw 42 is loosened to remove the first upright frame member 38 from the active rail for mounting on a different replacement rail. The active rail is then slidably removed from the housing and the replacement rail is mounted within the housing in its place.

The first upright frame member 38 further includes a wheel 44 mounted at the bottom end of the upright frame member to protrude slightly from the bottom surface of the upright frame member. The wheel 44 has an outermost surface lying in a common plane with the bottom side of the base member 24 when the housing is docked within the base member. In this manner the wheel 44 is arranged for rolling movement along the horizontal supporting surface that the bottom side of the base member is mounted on in a docked configuration of the clamping device. The wheel rolls about an axis perpendicular to the longitudinal direction of the rail to support the weight of the first jaw on the supporting surface as the rail is adjusted relative to the docked housing.

The first upright frame member 38 further defines a first clamping face 46 at an inner side of the first upright frame member nearest to the housing, adjacent the top end of the first upright frame member. The first clamping face 46 defines a clamping face for engaging one side of an object to be clamped and lies perpendicularly to the longitudinal clamping axis of the clamping device.

The top end of the first upright frame member 38 is further configured to receive a first jaw body 48 selectively mounted thereon. The first jaw body has a mounting socket 50 formed therein to be open to the bottom side of the jaw body to receive the top end of the first upright frame member 38 inserted therein for relative vertical sliding as the first jaw body is mounted onto the top end of the first upright frame member 38. The top end of the first upright frame member thus defines a mounting body which is shaped to cooperate with the mounting socket 50 so as to limit relative movement therebetween to vertical sliding movement as the first jaw body is mounted onto and removed from the first upright frame member 38. More particularly, the first jaw body 48 mounts onto the mounting body of the first upright frame member 38 for relative sliding along an axis line perpendicular to the longitudinal clamping axis.

The mounting socket 50 in the first jaw body 48 is also partly open at the inner side thereof to expose the first clamping face 46 on the first upright frame member 38. The inner side surface of the first jaw body 48 further defines a second clamping face 52 that is coplanar with and partly surrounds the first clamping face 46. The second clamping face 52 is wider in a lateral direction perpendicular to the longitudinal clamping axis to stabilize the object being clamped within the clamping device; however, for smaller objects the first clamping face 46 can be used alone as a clamping surface for clamping against one side of the object to be clamped.

A transverse screw 54 is penetrated through a side wall of the first jaw body 48 in alignment with the mounting socket 50 for selectively engaging the mounting body at the top end of the first upright frame member in a mounted position of the first job body so that tightening the screw 54 within its respective threaded bore in the first jaw body selectively locks the position of the first jaw body 48 mounted onto the first upright frame member 38. Loosening the transverse screw 54 enables the first jaw body 48 to be removed and interchanged with an auxiliary first jaw 56.

The auxiliary first jaw 56 shown in some of the figures includes a main jaw body having a mounting socket 58 formed therein which is suitably shaped for mating for a relative vertical sliding movement with the mounting body at the top end of the first upright frame member 38 similarly to the first jaw body 48 with which the auxiliary first jaw 56 is interchanged. The auxiliary first jaw 56 spans across the first clamping face 46 and defines a closed mounting loop 60 formed on the inner side surface of the main jaw body so as to be suitable for receiving a strap anchored thereon. A strap can be used in various applications for surrounding larger objects to be gripped in the manner of a strap wrench for example or for applying a tension to an object by securing part of the object to the first upright frame member using a strap.

The housing 16 of the clamping device includes a through passage 62 extending transversely through a bottom end of the housing 16 which is shaped to receive the rail 14 therein for relative longitudinal sliding movement in the direction of the rail. The cross-sectional area of the passage 62 has an hourglass shape which matches the hourglass shape of the profile of the rail 14 received therein. Internally within the housing, there is supported two guide blocks 64 at the laterally opposing sides of the passage 62 which have inner running surfaces matching the profile of the side recesses 28 in the rail respectively. The guide blocks are fastened on corresponding internal surfaces of the housing such that the guide blocks are interchangeable if they become worn. Preferably the guide blocks are formed of a material having a low coefficient of friction such as a plastic material commonly used in bushings and the like to provide a smooth and low friction sliding contact between the rail and the housing as the rail is displaced longitudinally relative to the housing.

The housing 16 extends upwardly from the passage 62 in the bottom end thereof to effectively define a second upright frame member of the overall clamping frame of the clamping device. The second jaw 22 is supported by the motorized driving assembly in proximity to a top end of the housing 16 for alignment with the first jaw at the top end of the first upright frame member 38 as described in further detail below.

The components of the latch 18 are supported on the housing 16 immediately above the passage 62. The latch includes a spur gear 66 rotatably supported within the housing above the rail such that the gear teeth of the spur gear 66 mesh in engagement with the row of gear teeth extending longitudinally along the latching strip 30 at the top of the rail 14 whereby the spur gear 66 rotates together with sliding movement of the rail relative to the housing. A latch body 68 of the latch is pivotally coupled on the housing above the spur gear and includes a first arm 70 extending downward from the pivot to a bottom end including locking teeth 72 formed thereon which engage one side of the spur gear to selectively prevent rotation of the spur gear 66 and thereby lock the sliding of the rail relative to the housing.

The latch body 68 further includes a second arm 74 extending laterally outward from the pivot when the lever is in a locked position. While the latch body 68 is somewhat biased into an engaged position with the spur gear for locking the rail under force of gravity, use of an additional spring is preferred to further bias the latch into the locked position thereof. The second arm 74 of the latch body defines a lever which protrudes outwardly from the housing to be readily engaged by a finger of the user for releasing the latch by lifting the outer end of the lever upwardly which in turn pivots the latch body 68 to displace the locking teeth 72 on the first arm 70 away from the spur gear into a released position of the latch where the rail is freely slidable and the spur gear 66 is freely rotatable relative to the housing with the sliding of the rail.

To assist in retaining the latch 18 in the engaged position in which the latch locks the spur gear 66 and the rail 14 against movement relative to the housing 16, an additional transverse locking pin 75 is mounted slidably within a respective bore in the housing 16 for movement between locked and unlocked positions relative to the latch body 68. The pin 75 is slidable along an axis lying parallel to the pivot axis of the latch body 68. In the locked position, the pin 75 extends into a corresponding aperture in the latch body 68 to prevent movement of the latch body away from the engaged position in which the latch body is engaged with the spur gear 66. In the unlocked position, the pin 75 is disengaged from the latch body 68 so that the latch body is freely movable against biasing without interference from the pin 75 from the engaged position to the disengaged position of the latch body. The locking pin 75 protrudes laterally outwardly from the side of the housing 16 so that an outer end of the pin is externally accessible for manual displacement by the operator between the locked and unlocked positions of the pin.

The base member 24 includes a flat bottom side 76 arranged to be mounted flat against the horizontal supporting surface in a mounted position. Mounting flanges 78 at the bottom of the base member include fastener apertures therein to selectively fasten the base member onto the horizontal supporting surface if desired. A cradle is formed on the base member 24 at a central location by upright side walls 80 extending upwardly from the bottom flanges 78 to a central socket 82 of the cradle which is open at the top end thereof and which is shaped to receive the bottom end of the housing inserted therein for relative vertical sliding into and out of the socket 82. Slots 84 are formed at opposing ends of the socket 82 in the longitudinal direction of the rail to receive the rail 14 extending through the base member 24 when the bottom end of the housing is mounted within the base member. When the housing is supported within the base member, the rail 14 is supported parallel to the horizontal supporting surface in close proximity to the supporting surface without interfering with the relative sliding of the rail in the longitudinal direction thereof relative to the housing and the base member 24 supporting the housing therein.

The motorized driving assembly that supports the second jaw relative to the housing 16 generally includes a collar member 86 mounted internally within the housing to be rotatably supported on suitable bearings 88 so as to be rotatable about a respective axis of the collar member and is concentric with the longitudinal clamping axis of the clamping device. The collar member 86 is driven to rotate relative to the housing by a drive motor 90 supported on the housing as described in further detail below. The collar member is internally threaded.

The driving assembly further includes a screw member 92 which is externally threaded so as to enable the screw member 92 to be mounted within the collar member with the external threads of the screw member in mating connection with the internal threads of the collar member to form a threaded connection between the collar member and the screw member. The screw member 92 mounts the second clamping jaw 22 on the inner end of the screw member which is nearest to the opposing first jaw.

An inner jaw body 94 is mounted on the inner end of the screw member in which the inner jaw body 94 defines a first clamping face 96 of the second jaw at inner side surface of the inner jaw body nearest to the opposing first jaw. The first clamping face 96 is parallel to the corresponding first clamping face of the first jaw and is perpendicular to the longitudinal clamping axis so that the object to be clamped can be clamped between the first clamping face 96 of the second jaw and the corresponding first clamping face on the first jaw.

The inner jaw body 94 is further supported relative to the housing by two stabilizer bars 98. Each bar 98 is mounted at one end to be fixed to the inner jaw body and mounted at the opposing end to be longitudinally slidable relative to the housing along a respective axis parallel to the longitudinal clamping axis. The stabilizer bars 98 are positioned at diametrically opposing sides of the screw member 92 to be spaced outwardly above and below the screw member such that the sliding axes of the stabilizer bars 98 and the longitudinal axis of rotation of the screw member 92 all lie in a common vertical plane. In addition to guiding the movement of the second jaw in the direction of the longitudinal clamping axis, the stabilizer bars 98 also prevent rotation of the inner jaw body 94 and the screw member 92 about a longitudinal axis of the screw relative to the housing. In this manner, when the collar member 86 is driven to rotate by the drive motor 90, the threaded connection between the collar member and the screw member forces the screw member 92 to translate longitudinally relative to the housing in the direction of the clamping axis. Changing the direction of rotation of the collar member changes the direction of translating movement of the screw member.

A pressure sensor 100 is provided on the inner jaw body 94 in operative connection to the first clamping face 96 for measuring the clamping force applied by the second jaw to the object to be clamped and to generate an appropriate clamping signal communicated to a controller 102 mounted internally within the housing. The controller 102 in the illustrated embodiment is a printed circuit board having a memory storing programming instructions thereon and a processor for executing the programming instructions to execute the various functions of the clamping device described herein. One or both stabilizer bars 98 may comprise a hollow tubular structure to provide a wired connection through one of the bars 98 between the pressure sensor 100 on the inner jaw body 94 and the printed circuit board of the controller 102 within the housing.

A battery 103 supplies electrical power to the printed circuit board of the controller 102 in which the battery is also located internally within the housing. A charging port 105 is formed externally on a battery casing portion of the housing and allows for connection to an external electrical supply for charging the battery when required.

The second jaw further includes a second jaw body 104 which mounts onto the inner jaw body 94 similarly to the mounting of the first jaw body 48 onto the mounting body of the first upright frame member 38 of the first jaw. More particularly, the second jaw body 104 defines a second clamping face 106 of the second jaw which is coplanar with and surrounds the first clamping face 96 of the second jaw so as to be similarly perpendicular to the longitudinal clamping axis. The second clamping face 106 protrudes laterally outward from both sides of the first clamping face 96 so as to be wider in a horizontal and lateral direction perpendicular to the longitudinal clamping axis than the first clamping face 96 alone, similarly to the arrangement of the second clamping face 52 relative to the first clamping face 46 of the first jaw.

The second jaw body 104 includes a mounting socket 108 formed internally therein which is open to the bottom of the second jaw body for fitting part of the inner jaw body 94 therein to form a mating connection that couples the second jaw body 104 to the inner jaw body 94 for relative vertical sliding movement therebetween along a transverse axis perpendicular to the longitudinal clamping axis. The mounting socket 108 is also partially open at the inner side of the second jaw body to receive the portion of the inner jaw body defining the first clamping face thereon within the opening at the inner side of the second jaw body that is nearest to the opposing first jaw body. The internal mounting socket 108 is different in configuration than the internal mounting socket of the first jaw body such that the first and second jaw bodies can only be mounted on their own respective mounting bodies of the first or second jaws respectively. A set screw 110 is penetrated through a side wall of the second jaw body in alignment with the mounting socket 108 for selective engagement with the inner jaw body 94 within the mounting socket so that tightening the set screw 110 selectively locks the second jaw body mounted onto the inner jaw body in a mounted position.

Loosening the set screw 110 permits removal of the second jaw body 104 to permit the second jaw body to be interchanged with an auxiliary second jaw 112. The auxiliary second jaw includes an internal mounting socket configured similarly to the mounting socket 108 of the second jaw body such that the auxiliary second jaw 112 also mates for vertical sliding onto the inner jaw body 94 of the second jaw. A similar set screw is used to retain the auxiliary second jaw relative to the inner jaw body. The auxiliary second jaw 112 is configured similarly to the auxiliary first jaw 56 by including a mounting loop 114 formed on the inner side of the body of the auxiliary second jaw nearest to the opposing first jaw to enable anchoring of a strap that can be tightened about larger objects being clamped or used to apply tension to an object as described above with regard to the auxiliary first jaw 56.

The drive motor 90 of the motorized driving assembly includes a cylindrical motor housing 116 supporting electric motor therein. The motor housing 116 is supported to protrude laterally outward from the housing parallel to the longitudinal clamping axis at a laterally opposing side of the housing from the second jaw. The motor housing 116 is supported by a mounting collar 118 fixedly mounted at the upper end of the housing which mounts the inner end of the motor housing 116 in fixed connection thereon such that a longitudinal axis of the motor housing and a central axis of the mounting collar are coaxial with the longitudinal clamping axis.

The drive motor 90 further includes a rotary output shaft 120 protruding from the inner end of the motor housing nearest to the clamping jaws to extend axially through the mounting collar 118. An adapter collar 122 is mounted to the rotary output shaft 120 using a keyed connection so that the adapter collar and the rotary output shaft rotate together relative to the motor housing 116 and the main housing 16 of the clamping device. The adapter collar 122 is mounted concentrically and in fixed relation to the collar member 86 of the motorized drive assembly. In this manner, the motor housing 116 is fixed relative to the main housing 16 of the clamping device by the mounting collar 118, while the rotary output shaft 120 of the motor that is driven to rotate is coupled by a direct connection through the adapter collar 122 to the collar member 86 used to drive longitudinal displacement of the screw member 92 and therefore the second jaw relative to the main housing 16. In this manner, the collar member 86 is connected by a fixed immovable connection to the rotary output of the shaft 120 with no intervening gears or other relatively movable drive components therebetween.

The drive motor 90 is actuated by an actuator handle 124 which is elongated in a direction of the longitudinal clamping axis while being sized to be gripped in a single hand of the user forming a fist about the actuator handle. Furthermore, the actuator handle is positioned directly above the lever 74 of the latch 18 such that the lever is within reach for operation with the index finger of the hand of the user that is gripped in a fist about the actuator handle due to the lever 74 protruding laterally from the housing 16 in the same direction that the actuator handle protrudes from the housing.

More particularly, the actuator handle 124 is a tubular sleeve mounted concentrically to surround the motor housing 116 of the drive motor so that the drive motor is fully contained within a hollow interior of the actuator handle 124. The actuator handle 124 is supported for rotation relative to the motor housing 116 by suitable bearings so as to be rotatable about a rotary axis of the actuator handle which is coaxial with the longitudinal clamping axis.

The actuator handle 124 is supported to be rotatable from a central neutral position in either one of two opposing directions including a first direction of rotation towards a first deflected position and a second direction of rotation opposite to the first direction towards a second deflected position. A set of centering springs 126 are operatively connected between the frame of the motor housing 116 and the actuator handle 124 for biasing the actuator handle from both of the first or second deflected positions back towards the central neutral position.

A position sensor 128 is mounted within the actuator handle 124 at the outer end of the motor housing 116 farthest from the main housing 16 of the clamping device. The sensor is operatively connected between the actuator handle 124 and the frame of the motor housing so as to measure an amount of angular deflection of the actuator handle in either one of the first or second directions towards the first or second deflected positions relative to the central neutral position. The position sensor then sends an appropriate signal through wiring along the exterior of the frame of the motor housing 116 but within the interior of the actuator handle 124 to communicate with the printed circuit board of the controller 102 within the interior of the main housing 16.

The housing further supports a display screen 130 on the top end thereof above the components of the motorized drive assembly. A power button 132 and an input button 134 are further located externally on the housing at the top end thereof adjacent to the display screen 130. The power button 132 toggles the controller between on and off powered states.

The controller 102 functions to operate actuation of the drive motor 90 in response to various inputs by the user and according to selected programming. When the actuator handle is rotated in a first direction of rotation towards the first deflected position, the controller activates the motor to drive displacement of the second jaw linearly towards the first jaw at a speed which is proportional to the measured deflection amount in the first direction of rotation. Likewise, when the actuator is rotated in a second direction of rotation towards the second deflected position, the controller activates the motor to drive displacement of the second jaw linearly away from the first jaw at a speed which is proportional to the measured deflection amount in the second direction of rotation. The actuator handle thus provided two-way variable speed control of the movement of the second jaw relative to the first jaw.

In either direction of movement of the second jaw relative to the first jaw, once the jaws engage the object to be clamped, continued actuation using the actuator handle instead functions to actuate the motor to increase the clamping pressure. The pressure sensor 100 senses the clamping pressure in real time and displays the measured pressure on the display screen 130 for viewing by the operator.

In a manual mode of operation of the clamp device, the user positions an object to be clamped between the jaws with one hand and grips the actuator handle with the other hand so that rotating the actuator handle in opposing first and second directions displaces the second jaw towards and away from the object to be clamped while the user aligns the object into a desired clamping position. Once the object has been engaged by both clamping jaws, continued actuation in the clamping direction increases the clamping pressure which is continued to be displayed on the display screen in real time. Releasing the actuator handle to allow the handle to return to the neutral position results in the drive motor being controlled to hold the clamping pressure constant. Deflecting the actuator handle in the opposing second direction initially acts to reduce the clamping pressure to a desired amount. Continuing to actuate the handle 124 in the second direction once pressure has been reduced to zero causes the second jaw to be displaced away from the first jaw to release the object being clamped at a speed proportional to the amount of deflection.

In an optional automatic mode of operation, once the object has been clamped and the clamping pressure on the display screen reaches a desired clamping pressure by the user, the user can actuate the input button 134 to provide an input to the controller that directs the controller to maintain the clamping pressure at the current pressure value automatically. In the instance that the object is being clamped for a longer period of time where some shrinkage may occur, for example in the instance of drying wood, the controller will sense the reduced clamping pressure on the object as measured by the pressure sensor 100 and can continue to actuate the drive motor 90 appropriately to maintain the clamping pressure at the pressure value set by the actuation of the input button 134.

The controller 102 is operatively connected to a pair of limit switches 136 which are supported internally within the housing for being triggered at opposing ends of the overall range of movement of the movable jaw respectively. The inner end of one of the uppermost one of the stabilizer bars 98 is provided with a stop 138 that moves between the two limit switches and actuates each limit switch upon reaching a corresponding one of the ends of the range of movement the movable jaw associated with that limit switch. The limit switches each generate a suitable signal transmitted to the controller 102 upon activation by the stop 138 to indicate to the controller that the movable jaw has reached one end of the range of movement. Any continued actuation of the motor to drive the movable jaw beyond the end of the range of movement is then no longer permitted by the controller; however, actuation signals to return the movable jaw within the normal range of movement remain permitted.

The controller 102 further includes a transceiver incorporated within the printed circuit board which provides wireless communication with an auxiliary input device (not shown). The auxiliary input device may be any form of suitable electronic device capable of wireless communication with the controller such as a smart phone or other mobile electronic device capable of executing programming thereon for controlling the operation of the controller for example. In other instances, the auxiliary input device may comprise a dedicated electronic device having one or more input buttons thereon such as a foot pedal arranged to be supported on the ground and actuated by stepping action with a foot of the user. For example, the foot pedal may include a two-way rocker switch which is biased to a neutral position but can be deflected downwardly at either of two opposing ends to drive actuation in two different directions of deflection similarly to the actuator handle 124. In this instance, the controller can accept inputs from the auxiliary input device instead of the actuator handle so that the user can drive the clamping jaws towards and away from one another under control of the motorized driving assembly using inputs from a foot being rocked between opposing toe and heel ends of the two-way rocker switch.

The general use of the clamping device typically starts with selecting a rail of appropriate length so that the object to be clamped is within the clamping range of the jaws when supported by the rail. With the second jaw being positioned nearest to the housing within its respective range of positions relative to the housing, the position of the rail can then be selected relative to the housing so that the distance between the first jaw and the second jaw is slightly greater than the corresponding dimensions of the object to be clamped. Adjustment of the rail is accomplished by placing the hand of the user loosely about the actuator handle so that the index finger can lift the lever towards the actuator handle to release the latch. Once the rail has been properly positioned, the lever is released so that the latch locks the position of the rail relative to the housing. The user then actuates the drive motor by angularly deflecting the actuator handle as described above to drive the second jaw relative to the housing and relative to the first jaw held fixed to the housing by the latch.

The base member 24 allows the housing to be docked relative to a horizontal supporting surface. In this position, the rail is supported at the bottom of the clamping device adjacent to the supporting surface. The first upright frame member 38 supporting the first jaw and the housing 16 (acting as a second upright frame member supporting the second jaw) both extend in a common radial direction away from the rail which is vertically upward in the docked position so that the first and second jaws are offset from the rail in a common upward/radial direction. The motorized drive assembly including the drive motor and the actuator handle are also supported on the housing to be offset from the rail in the same common radial direction so as to be similarly spaced above the rail in the docked position.

Since various modifications can be made in my invention as herein above described, and many apparently widely different embodiments of same made, it is intended that all matter contained in the accompanying specification shall be interpreted as illustrative only and not in a limiting sense.

1. A clamping device for clamping an object, the device comprising:
a clamping frame;
a first jaw supported on the clamping frame in fixed relation to the clamping frame; a motorized driving assembly supported on the clamping frame; and
a second jaw supported on the clamping frame by the motorized driving assembly so as to be movable towards and away from the first jaw on the clamping frame along a longitudinal clamping axis;
wherein the motorized driving assembly comprises:
a drive motor operatively connected between the second jaw and the clamping frame so as to drive displacement of the second jaw relative to the first jaw; and
an actuator handle supported for pivotal movement relative to the clamping frame about a rotary axis of the actuator handle; wherein the drive motor drives the second jaw towards the first jaw in response to displacement of the actuator handle in a first direction of rotation about the rotary axis; and
wherein the drive motor drives the second jaw away from the first jaw in response to displacement of the actuator handle in a second direction of rotation about the rotary axis.

2. The clamping device according to claim 1 wherein the rotary axis lies parallel to the longitudinal clamping axis.

3. The clamping device according to claim 1 wherein the actuator handle is elongated along the rotary axis of the actuator handle and the actuator handle is shaped to be received within a gripped fist of a user.

4. The clamping device according to claim 1 wherein:
the drive motor drives the second jaw towards the first jaw in response to displacement of the actuator handle in the first direction of rotation about the rotary axis from a neutral position towards a first deflected position;
the drive motor drives the second jaw away from the first jaw in response to displacement of the actuator handle in the second direction of rotation about the rotary axis from the neutral position towards a second deflected position; and
the actuator handle is biased from each of the first deflected position and the second deflected position towards the neutral position.

5. The clamping device according to claim 4 wherein the drive motor displaces the second jaw relative to the first jaw at a speed which is proportional to an amount of deflection of the actuator handle from the neutral position towards either of the first deflected position or the second deflected position.

6. The clamping device according to claim 1 wherein:
the motorized drive assembly includes a screw member having a screw axis lying parallel to the longitudinal clamping axis and a collar member supported about the screw member in which the collar member is internally threaded and forms a threaded connection with the screw member; and
a first member among the screw member and the collar member is fixed relative to the second jaw and a second member among the screw member and the collar member is driven to rotate by the drive motor whereby the second jaw is displaced along the longitudinal clamping axis.

7. The clamping device according to claim 6 wherein the second member is directly coupled in fixed relation to a rotary output of the drive motor.

8. The clamping device according to claim 6 wherein the first member is the screw member and the second member is collar member.

9. The clamping device according claim 1 wherein the actuator handle comprises a sleeve receiving the drive motor within a hollow interior of the sleeve.

10. The clamping device according to claim 1 wherein the clamping frame comprises:
an elongated rail extending parallel to the longitudinal clamping axis and supporting the first jaw fixedly thereon;
a housing operatively connected to the elongated rail such that the rail is slidable longitudinally in a direction of the longitudinal clamping axis relative to the housing; and
a latch arranged to selectively lock a position of the elongated rail relative to the housing;
the motorized driving assembly supporting the second jaw on the housing of the clamping frame such that the second jaw is movable in the direction of the longitudinal sliding axis relative to the housing;
whereby the second jaw is movable relative to the first jaw either by displacing the first jaw and the elongated rail relative to the housing or by displacing the second jaw relative to the housing using the drive motor.

11. The clamping device according to claim 10 wherein an overall range of movement of the first jaw and the elongated rail relative to the housing in the direction of the longitudinal sliding axis is greater than an overall range of movement of the second jaw relative to the housing in the direction of the longitudinal sliding axis.

12. The clamping device according to claim 11 further comprising an auxiliary rail having a length which is different than a length of the elongated rail wherein the auxiliary rail and the elongated rail are interchangeable with one another.

13. The clamping device according to claim 10 wherein the latch is pivotally supported on the housing, wherein the latch is biased towards an engaged position locking the elongated rail in position relative to the housing, and wherein the latch includes a lever arranged to be engaged by a user to release the elongate rail from the latch.

14. The clamping device according to claim 13 wherein the actuator handle is shaped to be received within a gripped fist of the user and wherein the lever is positioned adjacent the actuator handle so as to actuatable by an index finger of said gripped fist of the user when gripping the actuator handle.

15. The clamping device according to claim 10 wherein the latch comprises a spur gear rotatably supported on the housing in meshing engagement with a row of gear teeth extending along the elongated rail and a latch body arranged to selectively engage the spur gear and thereby lock the elongated rail relative to the housing by preventing rotation of the spur gear.

16. The clamping device according to claim 10 wherein the first jaw is offset radially from the elongated rail in a first direction and wherein the housing extends from the elongated rail in said first direction towards the drive assembly and the second jaw such that the drive assembly is also offset radially from the elongated rail in said first direction.

17. The clamping device according to claim 10 further comprising a base member having (i) a bottom side arranged to be supported on a horizontal supporting surface and (ii) a socket formed therein having an open top arranged to receive a bottom end of the housing inserted downward therein such that the elongated rail extends parallel to the horizontal supporting surface and the elongated rail is longitudinally adjustable relative to the housing and the base member, wherein the first jaw, the second jaw, and the motorized drive assembly are supported above the elongated rail in a mounted position of the housing within the base member.

18. The clamping device according to claim 10 wherein the elongated rail comprises (i) an extruded main body spanning a length of the elongate rail and being formed of a first metal and (ii) a latching strip extending along a length of the extruded main body and being formed of a second metal, wherein the latching strip is operatively connected to the latch to selectively lock the elongated rail relative to the housing, and wherein the second metal is harder and denser than the first metal.

19. The clamping device according to claim 1 wherein the motorized driving assembly further comprises a transceiver arranged for wireless communication with an auxiliary input device, the drive motor being operative to drive movement of the second jaw relative to the first jaw responsive to a wireless input signal from the auxiliary input device.

20. A clamping device for clamping an object, the device comprising:
an elongated rail having a longitudinal axis;
a first jaw supported in fixed relation on the elongated rail;
a housing operatively connected to the elongated rail such that the elongated rail and the first jaw supported thereon are longitudinally slidable relative to the housing in a direction of said longitudinal axis; a latch arranged to selectively lock a position of the elongated rail relative to the housing;
a motorized driving assembly supported on the housing;
a second jaw supported on the housing by the motorized driving assembly such that the second jaw is movable relative to the housing towards and away from the first jaw on the elongated rail along a longitudinal clamping axis lying parallel to the longitudinal axis of the elongated rail;
the motorized driving assembly including (i) a drive motor operatively connected between the second jaw and the housing so as to drive displacement of the second jaw relative to the first jaw and (ii) an actuator operatively connected to the drive motor such that the drive motor drives displacement of the second jaw responsive to actuation by the actuator;
whereby the second jaw is movable relative to the first jaw either by displacing the first jaw and the elongated rail relative to the housing or by displacing the second jaw relative to the housing using the drive motor.
